(19) United States
(12) Patent Application Publication
(10) Pub. No.: US 2010/0156326 A1
(43) Pub. Date: Jun. 24, 2010

(54) ELECTRONIC CANDLE

(76) Inventor: Kuo-Fang CHEN, Sindian City (TW)

Correspondence Address: Muncy, Geissler, Olds & Lowe, PLLC, 4000 Legato Road, Suite 310, FAIRFAX, VA, 22033, US

(21) Appl. No.: 12/475,946

(22) Filed: Jun. 1, 2009

(30) Foreign Application Priority Data
Dec. 18, 2008 (CN) 200820129627.7

(51) Int. Cl. H05B 39/00; F21V 21/00; F21L 4/00

(52) U.S. Cl. 315/313; 362/392; 362/157

(57) ABSTRACT

An electronic candle includes a bottom seat on which is a circuit board. The circuit board includes at least a first illuminating element, the bottom seat contains a control set which is coupled with the circuit board, and the bottom seat is covered by a cap, an upper part of which is a candle sheath approximately in a candle shape. An interior of the candle sheath receives at least a second illuminating element, and the upper part of the cap is provided additionally with a speaker. The first illuminating element can produce a flashing effect following rhythm, through collaboration of the control set and the circuit board. The circuit board is provided with a storage unit to store a music file, such that a user can store an MP3 file or an MP4 file into the storage unit, to facilitate listening in a later time.

### BACKGROUND OF THE INVENTION

a) Field of the Invention

The present invention relates to an electronic candle, and more particularly to an electronic candle which can display a various visual effect of light and flashing, following beats of rhythm.

b) Description of the Prior Art

Music can make people feel pleasant, comfortable and relaxed. Rhythm of notes can shake people's spirit; music can spread out without limitation and is beyond a boundary of countries. Music can even allow people to feel different if fitting with an audio-video effect. In this diversified society, music can be accessed anywhere, especially that electronic music can be accessed on a network and can be listened on-line or downloaded to a disk. There are a lot of devices on a market to play music, such as an MP3 (Movie Picture Experts Group Layer-3 Audio) personal disk or an MP4 (Movie Picture Experts Group Layer-4 Audio) video disk which can all be compatible with a music file, and a screen panel of which is even changeful to provide a feeling of creating a mood.

Therefore, visual enjoyment has become one of qualities that people pay more attention to, and this visual effect has been an essential part emphasized for each merchandise, especially that a music machine in a candle shape is even a product developed actively by each vendor. There are many kinds of electronic candles to be selected nowadays, and the electronic candle usually includes a candle and an electronic device. The electronic device can be further used as a candlestick directly, and an interior of the electronic device is provided with an electronic element to illuminate or play music when the candle is ignited, so as to create flashing or a music effect. This kind of electronic candle is more advanced than a conventional candle, but only provides for listening to music without having a smell of the candle. In addition, most of the electronic devices are provided with switches individually and then assembled with the candles for use. Therefore, a user has to operate an on/off by oneself, which is not very convenient in use.

### SUMMARY OF THE INVENTION

Accordingly, the primary object of the present invention is to provide an electronic candle which changes light, colors and flashing by itself, following rhythm. The electronic candle includes a bottom seat, a side of which is provided with a connection set for transmitting signals, and on which is provided with a circuit board. The circuit board is provided with at least a first illuminating element, and the bottom seat is provided with a control set which is coupled with the circuit board. A cap covers the bottom seat, and an upper part of the cap is provided with a candle sheath approximately in a candle shape. An interior of the candle sheath receives at least a second illuminating element, and the upper part of the cap is provided additionally with at least a speaker, with the speaker and the second illuminating element being coupled with the circuit board. The control set includes at least a press element and at least a switch element. When the electronic candle is to be activated, the electronic candle can operate through the switch element, and the first illuminating element can change flashing following rhythm. On the other hand, volume of music can be controlled or music programs can be selected through the press element. Moreover, an interior of the circuit board is provided with a storage unit to store music files, such that a user can store music through the storage unit and read out the music directly from the storage unit when he or she needs to listen to that music. By the aforementioned technologies, the issues existing in the conventional electronic candle that it is only used to listen to music, no smell of the candle is available, and it is not very convenient in using the electronic candle, as the user needs to operate by oneself the on/off of the candle, due to that most of the circuit boards are provided individually with the switches and then assembled with the candles for use, can be solved, such that the practical progressiveness is achieved by that the present invention can play all kinds of music files, such as the MP3 or the MP4, and that many music files can be saved into the storage unit and can be directly selected from the storage unit to play when listening to the music file.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of a preferred embodiment of the present invention.

FIG. 2 shows a three-dimensional view of a preferred embodiment of the present invention.

FIG. 3 shows an exploded view of a preferred embodiment of the present invention.

FIG. 4 shows a local schematic view of a preferred embodiment of the present invention.

FIG. 5 shows a schematic view of an implementation of a preferred embodiment of the present invention.

### DETAILED DESCRIPTION OF THE PREFERRED EMBODIMENTS

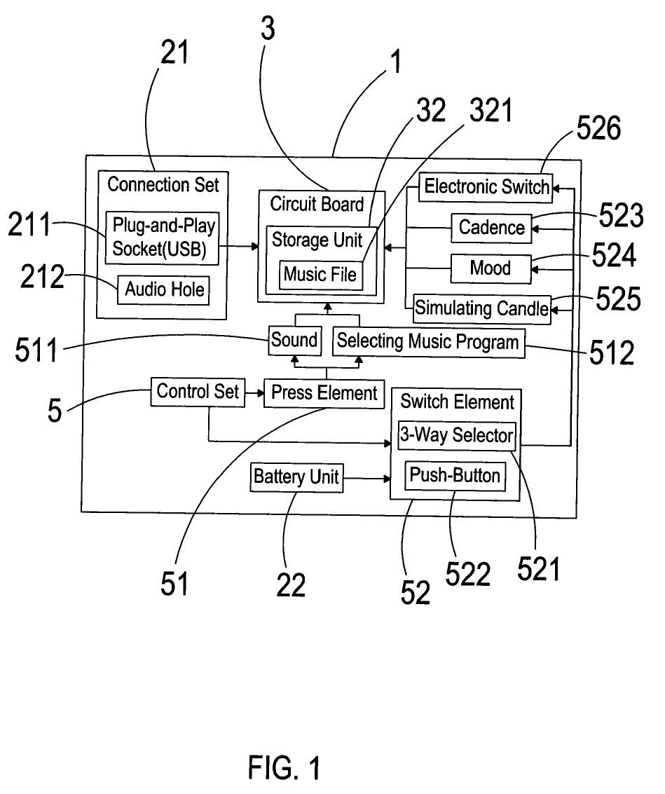

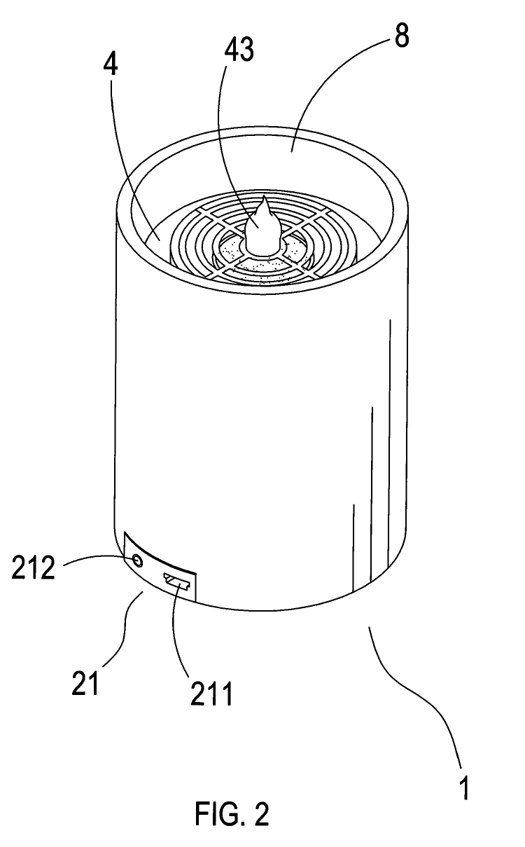

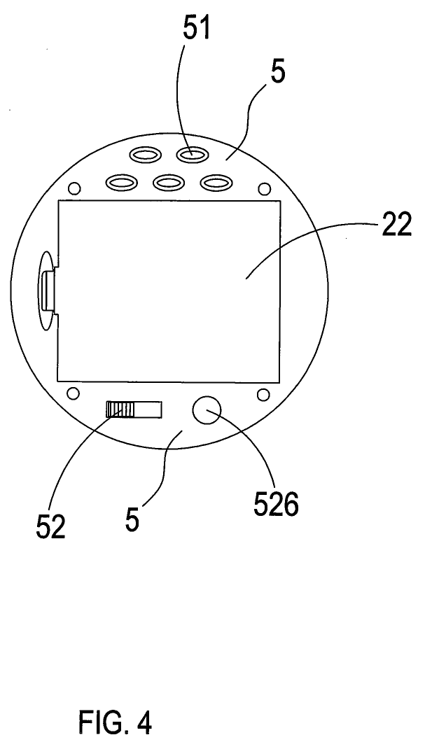

Referring to FIGS. 1 to 4, it shows a block diagram, a three-dimensional view, an exploded view and a local schematic view, of a preferred embodiment of the present invention. An electronic candle 1 comprises a bottom seat 2, a circuit board 3, a cap 4 and a control set 5. A side of the bottom seat 2 is provided with a connection set 21 for transmitting signals, the connection set 21 includes a plug-and-play socket (USB, universal serial bus) 211 and an audio hole 212, and is coupled with the circuit board 3 on the bottom seat 2. The circuit board 3 is provided with at least a first illuminating element 31 which is a light emitting diode, and an interior of the circuit board 3 is provided with a storage unit 32 which is able to store at least a music file 321 (an MP3 file or an MP4 file). The cap 4 covers on the bottom seat 2, and an upper part of the cap 4 is provided with through-holes 41, a side of which is provided with a speaker 42, and the other side of which is provided with a candle sheath 43 approximately in a candle shape. An interior of the candle sheath 43 receives a second illuminating element 431 which is a light emitting diode, whereas the speaker 42 and the second illuminating element 431 are electrically connected with the circuit board 3, respectively. In addition, an outer periphery of the cap 4 is sheathed with a housing 8, the control set 5 is electrically connected with the circuit board 3 and includes at least a press element 51 and at least a switch element 52. The press element 51 is able to control the music file 321 in the aforementioned storage unit 32, and the switch element 52 is provided with a function of controlling the first illuminating element 31 and the second illuminating element 431. When the switch element 52 controls the first illuminating element 31, the first illuminating element 31 can flash following rhythm played by the music file 321; if the rhythm gets stronger, the first illuminating element 31 flashes rapidly, on the contrary, if the rhythm gets weaker, the first illuminating element 31 flashes slowly. Moreover, the bottom seat 2 is further provided with a battery unit 22 which provides necessary electricity to the electronic candle 1.

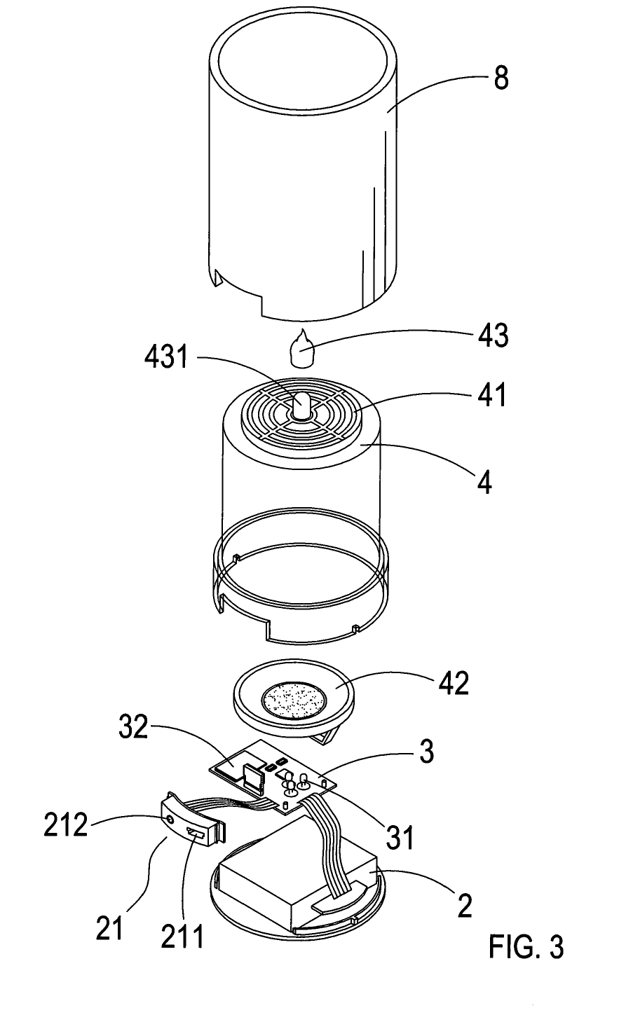

On the other hand, referring to FIG. 1 and FIG. 3, the control set 5 includes the press element 51 and the switch element 52. The press element 51 controls the music file 321 in the storage unit 32, such as volume of sound 511 or selecting a music program 512. The switch element 52 can be a 3-way selector switch 521 or a push-button switch 522, and includes a switch which controls the first illuminating element 31 to flash in rhythm according to cadence 523 played by the music file 321. The switch element 52 is further provided with a function of allowing the first illuminating element 31 to flash at a pre-set frequency to create a mood 524 of different color, another function of allowing the second illuminating element 431 to simulate flashing of a candle 525, and still another function of serving as an electronic switch 526 of the electronic candle 1.

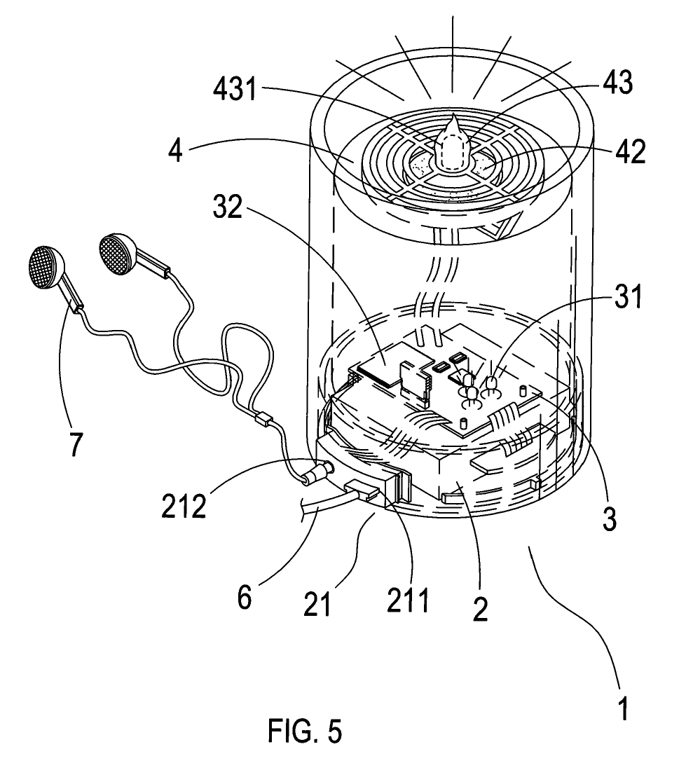

Referring to FIG. 1 and FIG. 5, it shows a block diagram and a schematic view of an implementation, of a preferred embodiment of the present invention. An electronic candle 1 is composed of a bottom seat 2, a side of which is provided with a connection set 21 for transmitting signals. The connection set 21 includes a plug-and-play socket (USB) 211 and an audio hole 212. The bottom seat 2 is provided with a circuit board 3, an interior of which is provided with a storage unit 32 to store a music file 321. The circuit board 3 is provided with at least a first illuminating element 31, and the bottom seat 2 is provided with a control set 5 which is coupled with the circuit board 3. The bottom seat 2 is covered by a cap 4, an upper part of which is provided with a candle sheath 43 approximately in a candle shape. An interior of the candle sheath 43 receives at least a second illuminating element 431. In addition, the upper part of the cap 4 is provided additionally with at least a speaker 42, and the control set 5 includes at least a press element 51 and at least a switch element 52. Accordingly, when a user is to use the electronic candle 1 to listen to music, he or she can transmit the music file 321 into the storage unit 32 through the plug-and-play socket (USB) 211 and with a transmission wire 6, and can select to listen through an earphone 7 or play through the speaker 42, by the audio hole 212. When listening to the music, he or she presses down an electronic switch 526 to activate the electronic candle 1, and then selects a music program through the press element 51; in a mean time, volume of sound 511 can be adjusted. When playing the music, the user can select a visual effect through the switch element 52; the visual effect includes a switch which controls the first illuminating element 31 to flash in rhythm according to cadence 523 played by the music file 321, a mood 524 of different color which is created by enabling the first illuminating element 31 to flash at a pre-set frequency, and an effect which is created by allowing the second illuminating element 431 to simulate a candle 525 to flash. Accordingly, the user can freely change a pattern of flashing and store his or her favorite music file 321 into the storage unit 32 to facilitate listening at a later time. Furthermore, the electronic candle 1 can support the music file 321 in a plurality of formats. Therefore, the present invention is provided with a strong and practical function, and is not comparable by the ordinary electronic candle.

Referring to all the drawings, the present invention is actually provided with following advantages:
1. When activating the electronic candle 1, multiple formats, such as the MP3 or the MP4, of the music file 321 can be supported; therefore, the compatibility is extremely high.
2. The circuit board 3 in the electronic candle 1 is provided with the storage unit 32 which can store the music file 321 to facilitate the user to listen in a later time, without connecting to an external play device. In addition, the user can select to use the earphone 7 or the speaker 42 to listen, which is diversified.
3. A side of the electronic candle 1 is provided with the connection set 21 which includes the plug-and-play socket (USB) 211, allowing the user to transmit the music file 321 to the storage unit 32 through the plug-and-play socket 211 and with the transmission wire 6, thereby achieving the effect of quickly updating the music file 321.
4. The electronic candle 1 is provided with three change types of light; one is the switch which controls the first illuminating element 31 to flash in rhythm following the cadence 523 played by the music file 321, another is the mood 524 of different color which is created by enabling the first illuminating element 31 to flash at a pre-set frequency, and the other is the effect which is produced by enabling the second illuminating element 431 to simulate the candle 525 to flash. Therefore, the advantage of providing the user with multiple variations to select is achieved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electronic candle comprising a bottom seat and a control set, wherein the bottom seat includes a circuit board, which is provided on the bottom seat, is provided with at least a first illuminating element, and an interior of which is provided with a storage unit to store at least one MP3 (Movie Picture Experts Group Layer-3 Audio) file or at least one MP4 (Movie Picture Experts Group Layer-4 Audio) file; and at least one switch element which is provided at a bottom of the bottom seat and is provided with a function to control the first illuminating element, with the first illuminating element flashing following rhythm played by the MP3 file or the MP4 file, when the switch element controls the first illuminating element.

2. The electronic candle according to claim 1, wherein a side of the bottom seat is provided with a connection set for transmitting signals.

3. The electronic candle according to claim 1, wherein the bottom seat is covered by a cap, an upper part of which is provided with a speaker and a candle sheath approximately in a candle shape, with an interior of the candle sheath receiving a second illuminating element, whereas, the speaker and the second illuminating element being electrically connected with the circuit board, respectively.

4. The electronic candle according to claim 1, wherein the control set further includes a press element.

5. The electronic candle according to claim 1, wherein the connection set further includes a plug-and-play socket (USB, universal serial bus) and an audio hole.

6. The electronic candle according to claim 1, wherein the bottom seat is further provided with a battery unit.

7. The electronic candle according to claim 1, wherein the first illuminating element is a light emitting diode.

8. The electronic candle according to claim 3, wherein the second illuminating element is a light emitting diode.

9. The electronic candle according to claim 1, wherein the switch is a 3-way selector switch or a push-button switch.

10. The electronic candle according to claim 1, wherein an outer periphery of the cap is sheathed with a housing.
